(19) United States
(12) Patent Application Publication
(10) Pub. No.: US 2012/0059604 A1
(43) Pub. Date: Mar. 8, 2012

(54) CONTACTLESS VIBRATION METER

(76) Inventors: Geeng-Jen Sheu, Taichung City (TW); Shih-Hung Yeh, Hemei Township (TW)

(21) Appl. No.: 13/225,732

(22) Filed: Sep. 6, 2011

(30) Foreign Application Priority Data
Sep. 7, 2010 (TW) 099130167

(51) Int. Cl. G06F 19/00

(52) U.S. Cl. 702/56

(57) ABSTRACT

A contactless vibration meter having a magnetic strip, a detector, and a processor is disclosed. The N-pole blocks of the magnetic strip are unequal lengths and the S-pole blocks of the magnetic strip are also unequal lengths, the detector is detecting the N-pole blocks of the magnetic strip with unequal lengths and the S-pole blocks of the magnetic strip with unequal lengths, and the voltage variation due to the change of the magnetoresistance of the detector is calculated by the processor, so as to transfer to corresponding vibrating waveform, thereby being capable of obtaining the vibrating information of the tested object. It is not limited by the space of the factory or the pattern of the tested object, and capable of being attached to detect immediately.

### FIELD OF THE INVENTION

The present invention generally relates to a vibration meter, and more particularly to a contactless vibration meter capable of detecting the vibration information of a tested object, being not limited by the space of the factory or the pattern of the tested object, and measuring immediately after installing on the tested object.

### BACKGROUND OF THE INVENTION

The dynamics and vibration of mechanical systems are of fundamental importance in the design of machinery. With the flourishing development and research for the fields of precision machinery, fault detection, diagnosis and monitoring, and micro-electromechanical system, the real-time, accurate and space-saving detect skills of the vibration information become very critical. The conventional vibration meter is mainly classified as contact type and contactless type. The contact type has to directly contact with the tested object to capture the vibration information, such as an accelerometer, but it is not applicable to precision machinery or micro-electromechanical system because there is obvious shift of dynamic characteristics between before and after the light micro-structure object attaches the accelerometer (i.e. the total mass has been changed). Furthermore, the contact area is easily to wear and damage the surface of the tested object to affect the next precision process.

Compared to the shortcomings of wear, damage and inaccuracy with the dynamic characteristic shift of contact type, the measurement of contactless type is capable of substantially improving accuracy due to without contacting the tested object. Therefore, the measurement skill of contactless type is preferred for the past few years and plays an important and indispensable role in dynamic measurement of mechanical system. As for the traditional contactless type, the Doppler Effect, such as Laser Doppler Vibrometer (LDV), is mainly applied for the optical technique.

However, the LDV must apply not only the Doppler Effect, but also He—Ne laser, to obtain obvious and accurate results. As results, the structure and module of the optical lens become more complicated and with higher cost. If the LDV is applied to machinery for general industries, it will increase the total equipment cost for the traders because of the additional He—Ne laser inspector. In addition, the light beam has to emit straightly, so the LDV is not suitable for the factories with narrow space. The functions and the situations of the LDV are limited. Therefore, a novel contactless vibration meter must include the functions of space-saving, low cost, easy installation, noise immunity, high sensitivity and lower power consumption, and etc.

Furthermore, the traditional vibration meter depends on the shape, pattern and application of the tested object, and it is without flexible installing function. The traditional vibration meter is usually rigid and therefore limited to have to be installed or arranged on the tested object in advance, such as the accelerometer or the LDV. Therefore, the traditional vibration meter has the disadvantages of rigid installation, so that the applications are limited. Therefore, a novel contactless vibration meter with the flexible installing function, such as portable and “adhere-and-sense” (similar to the function of “plug-and-play”), is necessary.

### SUMMARY OF THE INVENTION

An objective of this invention is providing a contactless vibration meter, which is capable of detecting the real-time vibration information of the tested object to obtain the vibration amplitude and its dynamic characteristic.

A second objective of this invention is providing a contactless vibration meter, which has the advantages of simple structure, lower cost, and being applicable for a tested object without the consideration about its shape and pattern.

A third objective of this invention is providing a contactless vibration meter, which has the advantages of space-saving, lower cost, easy installation, noise immunity, and high sensitivity, and no effect on the original distribution of the magnetic field in system process.

A fourth objective of this invention is providing a contactless vibration meter, which is with the flexible installing function, such as portable and “adhere-and-sense” (similar to the function of “plug-and-play”).

To achieve above objectives, a contactless vibration meter is disclosed and comprises a magnetic strip fixed on the surface of a tested object and being parallel to the vibrating direction, the magnetic strip having a first section, a second section and a central section, wherein the central section has a magnetic pole with N pole or S pole, the first section and the second section are connected to two ends of the central section respectively, the first section includes at least two first N-pole blocks and at least two S-pole blocks, the first N-pole blocks and the first S-pole blocks are alternatively arranged from the end of the first section close to the central section and a length of the first N-pole blocks and a length of the first S-pole blocks increase with increase the distance from the central section, and the second section includes at least two second N-pole blocks and at least two second S-pole blocks, the second N-pole blocks and the second S-pole blocks are alternatively arranged from the end of the second section close to the central section and a length of the second N-pole blocks and a length of the second S-pole blocks increase with increase the distance from the central section, and the first section and the second section are connected to the central section with N-pole or S-pole blocks thereof respectively which is opposite to the magnetic pole of the central section; a detector, attached at a position over the magnetic strip and including a fixed magnetic layer with a fixed magnetic direction, a free magnetic layer with a changeable magnetic direction influenced by an external magnetic field, an insulating layer separated the fixed magnetic layer from the free magnetic layer, two signal lines electrically connected to the fixed magnetic layer and the free magnetic layer respectively, and a power supply electrically connected to the signal lines; and a processor, electrically connected to the signal lines; wherein the magnetic strip passes through the detector in reciprocating motion when the tested object vibrates periodically in reciprocating motion, the changeable magnetic direction of the free magnetic layer is influenced by the magnetic fields of the respective N-pole blocks and the respective S-pole blocks of the first section and the second section to make the magnetic direction of the free magnetic layer be parallel or anti-parallel to the magnetic direction of the fixed magnetic layer; and result in obvious change of the magnetoresistance of the detector and a voltage or current output to the processor, and then the processor calculates the vibration information of the tested object.

The contactless vibration meter further comprises a second magnetic strip, being adjacent to the first magnetic strip and having at least two third N-pole blocks and at least two third S-pole blocks, the third N-pole blocks and the third S-pole blocks have the same length, and are alternatively and equally arranged; a second detector, disposed corresponding to the second magnetic strip to detect the change of the changeable magnetic direction of the free magnetic layer influenced by the magnetic field of the respective each third N-pole block and the respective each third S-pole block; and the processor electrically connecting with the detector and the second detector; wherein the processor receives the obvious variation of the magnetoresistance due to the changeable magnetic direction of the free magnetic layer detected by the detector and the second detector to result in obvious variation of a voltage or a current output to the processor, and then the processor integrally calculates a vibration information of the tested object.

Further features and advantages of the present invention will become apparent to those of skill in the art in view of the detailed description of preferred embodiments which follows, when considered together with the attached drawings and claims.

### BRIEF DESCRIPTION OF THE DRAWINGS

All the objects, advantages, and novel features of the invention will become more apparent from the following detailed descriptions when taken in conjunction with the accompanying drawings.

FIG. 1 illustrates a solid diagram of an embodiment of a contactless vibration meter applying to a tested object in accordance with the invention.

FIG. 2 illustrates a schematic diagram of a contactless vibration meter in accordance with the invention.

FIG. 3 illustrates an operation of the contactless vibration meter in accordance with the invention.

FIG. 4 illustrates another operation of the contactless vibration meter in accordance with the invention.

FIG. 5 illustrates another operation of the contactless vibration meter in accordance with the invention.

FIGS. 6A and 6B illustrate a working state diagram of the contactless vibration meter in accordance with the invention.

FIGS. 7A and 7B illustrate another working state diagram of the contactless vibration meter in accordance with the invention.

FIGS. 8A and 8B illustrate a working state diagram of the contactless vibration meter involving a second magnetic strip in accordance with the invention.

### DESCRIPTION OF THE PREFERRED EMBODIMENT

Referring now to the drawings where like characteristics and features among the various figures are denoted by like reference characters.

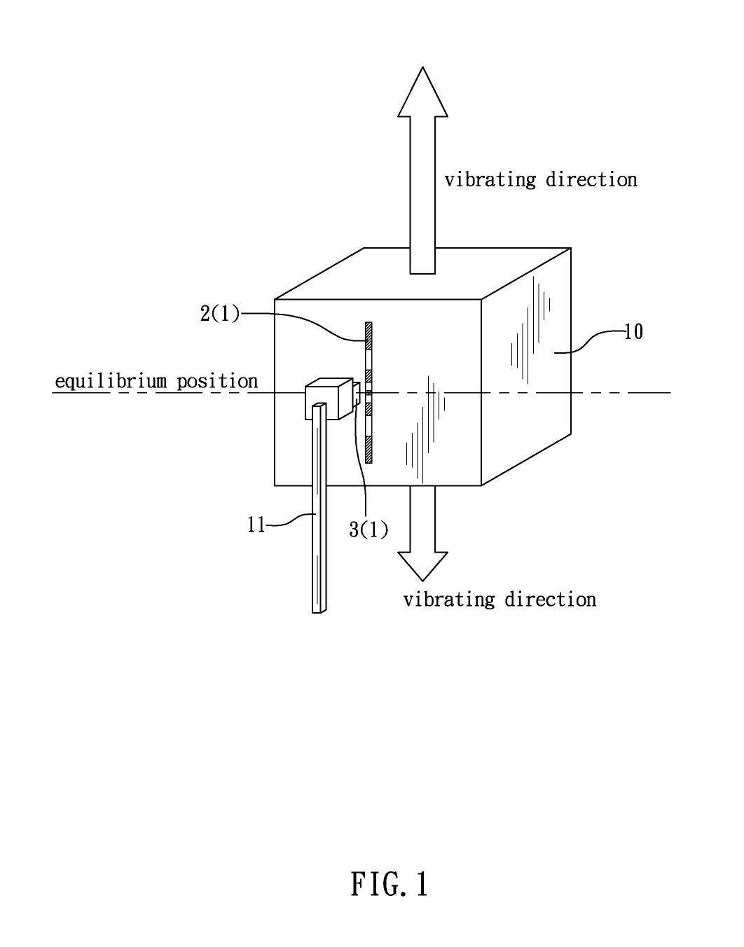

FIG. 1 illustrates a solid diagram of an embodiment of a contactless vibration meter applying to a tested object in accordance with the invention. Please refer to FIG. 1, the contactless vibration meter 1 is used for detecting and calculating the vibration information of the tested object 10, which is capable of applying to such as seismic analysis, automotive vibration analysis, spectrum analysis, and etc.

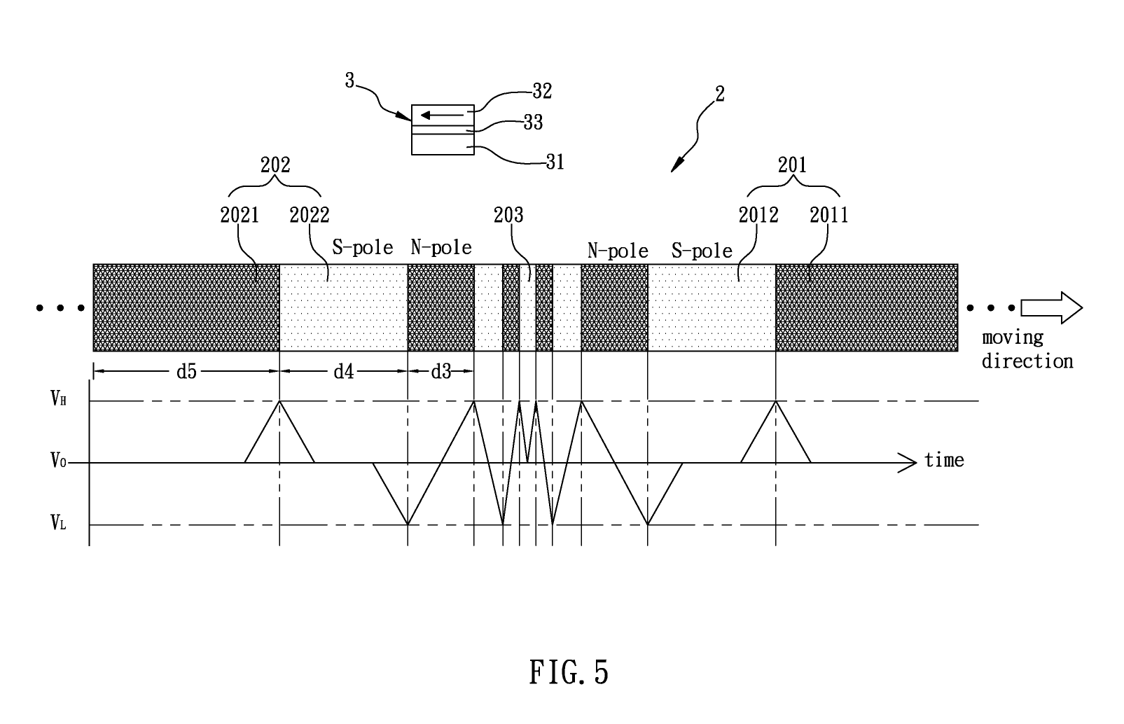

The contactless vibration meter 1 comprises a magnetic strip 2, a detector 3 and a processor 4. The magnetic strip 2 is attached on a surface of the tested object 10 and parallel to the vibrating direction. The detector 3 is mounted on a frame 11 and corresponding to an equilibrium position of the magnetic strip 2, wherein the equilibrium position is the central section 203 of the magnetic strip 2 (shown as FIG. 5). When the tested object 10 vibrates periodically in reciprocating motion, the magnetic strip 2 passes through the detector 3 in reciprocating motion.

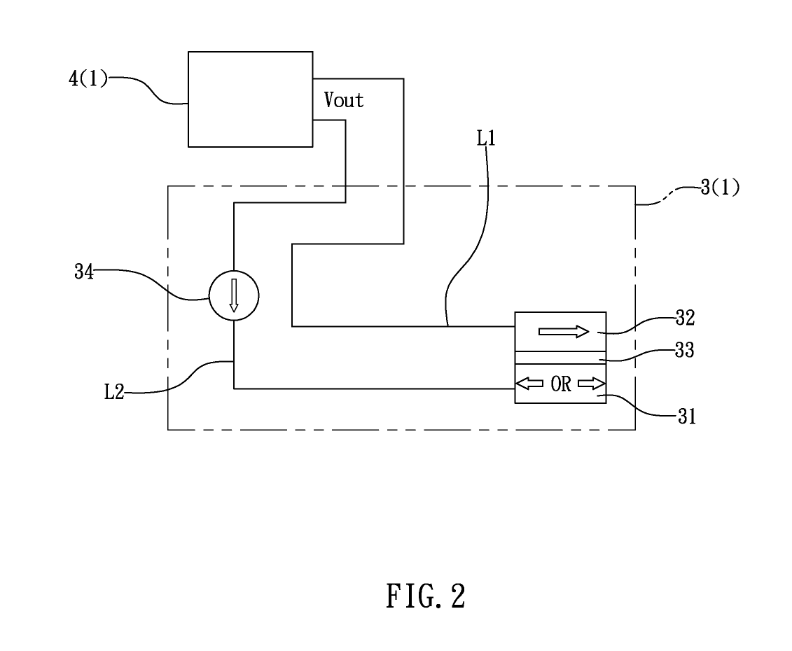

FIG. 2 illustrates a schematic diagram of a contactless vibration meter in accordance with the invention. Please refer to FIG. 2, The detector 3 includes a fixed magnetic layer 32, a free magnetic layer 31, an insulating layer 33, two signal lines L1 an L2, a power supply 34 and a processor 4, wherein the fixed magnetic layer 32 has a fixed magnetic direction, the free magnetic layer 31 has a changeable magnetic direction influenced by an external magnetic field, the insulating layer 33 separates the fixed magnetic layer 32 from the free magnetic layer 31, and the processor 4 is respectively connected to the fixed magnetic layer 32 and the free magnetic layer 31 by the two signal lines L1 and L2.

The magnetic direction of the fixed magnetic layer 32 can not be influenced by an external magnetic field, even the external magnetic field is removed. The material of the fixed magnetic layer 32 can be a conductive metal or an oxide with electric conductivity and magnetism, such as Fe_{81-X}Co_{X}Gₐ₁₉. The magnetic direction of the free magnetic layer 31 can be influenced by an external magnetic field and there is no residual magnetism when the external magnetic field is removed, and the material of the free magnetic layer 31 can be a conductive metal or an oxide with electric conductivity and magnetism, such as NiFe. The insulating layer 33 can be a non-magnetic metal layer (e.g. copper) or an isolating layer (e.g. aluminum oxide).

The spin physical characteristics can be applied to illustrate the principle of operation of the detector 3, which includes spin-up electrons and spin-down electrons. The electrons parallel to the magnetic moment of the magnetic layer are scattered less and perform lower resistance. But the electrons anti-parallel to the magnetic moment of the magnetic layer are easily collided with the magnetic moment of the magnetic layer and perform higher resistance. If the magnetic direction of the free magnetic layer 31 is parallel to the magnetic direction of the fixed magnetic layer 32, the spin of electrons anti-parallel to the magnetic moments of the fixed magnetic layer 32 and the free magnetic layer 31 are obstructed to scatter, but the electrons with parallel spin are easy to conduct. Therefore, the total resistance is relatively lower, so that the output voltage Vₒᵤₜ received by the processor 4 is relatively lower while the power supply 34 provides a constant current. If the magnetic moment direction of the free magnetic layer 31 is anti-parallel to the magnetic moment direction of the fixed magnetic layer 32, no matter what the spin-up electrons or spin-down electrons are obstructed to scatter by the fixed magnetic layer 32 or the free magnetic layer 31, and the total resistance is relatively higher, so that the output voltage Vₒᵤₜ received by the processor 4 is relatively higher while the power supply 34 provides a constant current. The digital signals of “0” or “1” can be obviously judged based on the magnitude of the output voltage Vₒᵤₜ received by the processor 4.

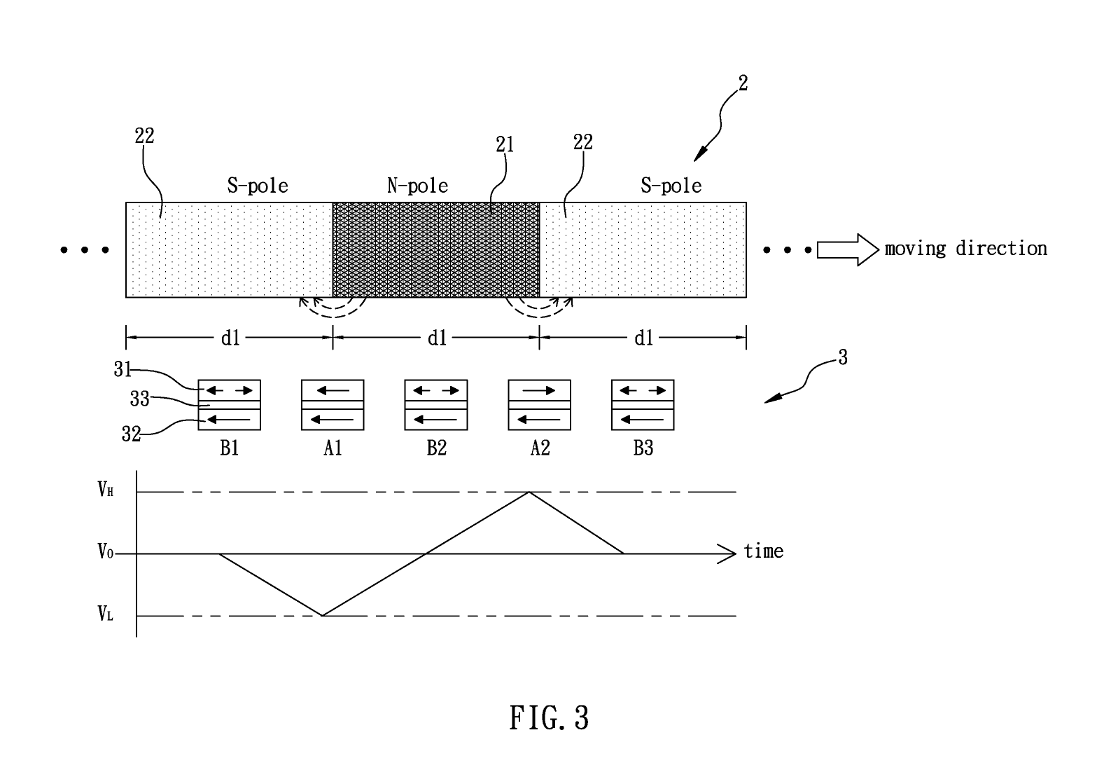

FIG. 3 illustrates an operation of the contactless vibration in accordance with the invention. Please refer to FIG. 3, for example, the magnetic strip 2 includes a N-pole block 21 and two S-pole blocks 22, and alternatively arranged by S-N-S, and the lengths of the blocks are equal and are represented by d1. With regards to the original magnetic direction (leftward as shown in FIG. 3) of the fixed magnetic layer 32 of the detector 3, it is defined as the forward direction (leftward as shown in FIG. 3) if the magnetic directions of the free magnetic layer 31 and the fixed magnetic layer 32 are parallel, and the internal resistance is lower. The forward output voltage V_{L} is lower while the power supply 34 provides a constant current. On the contrary, it is defined as backward direction (rightward as shown in FIG. 3) if the magnetic directions of the free magnetic layer 31 and the fixed magnetic layer 32 are anti-parallel, and the internal resistance is higher. The backward output voltage V_{H} is higher while the power supply 34 provides a constant current.

When the common boundary or junction of the N-pole block 21 and the S-pole block 22 moves under the detector 3 (i.e. the positions A1 and A2 as shown in FIG. 3), the changeable magnetic direction of the free magnetic layer 31 at position A1 is leftward (defined as forward direction) due to the external magnetic field of the magnetic strip 2 and the output voltage is the forward voltage V_{L} while being at position A1. The magnetic direction of the free magnetic layer 31 at position A2 is rightward (defined as backward direction) due to the external magnetic field of the magnetic strip 2 and the output voltage is the backward voltage V_{H} while being at position A2. When the central portion of the N-pole block 21 or the S-pole block 22 moves to the detector 3 (i.e. the positions B1, B2 and B3 as shown in FIG. 3), it is with no influence of the external magnetic field and the output voltage is offset voltage V_{O} because the forward magnetic field and the backward magnetic field at the central portion of the N-pole block 21 or the S-pole block 22 are balances off each other. The alternatively and equally arranged plurality of N-pole blocks 21 and S-pole blocks 22 pass through the detector 3 from left to right sequentially and the processor 4 is capable of receiving the output voltage (Vₒᵤₜ), which is the periodical variation with saw-toothed wave as shown in FIG. 3 (the saw-toothed wave is for example but not limited thereto), and then the “V_{L}” and “V_{H}” are capable of defining as the discrete signals “0” and “1”, respectively. The detector 3 passes one pole block once while the processor 4 receives a set of the discrete signals “0” and “1” and the moving distance is the same as the length d1 of the pole block, and further the sequencing of the discrete signals are transferred to corresponding moving distance of the tested object 10. Similarly, if the power supply 34 provides constant voltage, the output current received by the processor 4 is changed obviously and the sequencing of the discrete signals “0” and “1” can be defined based on the magnitude of the output current. The sequencing of the discrete signals are transferred to corresponding moving distance of the tested object 10.

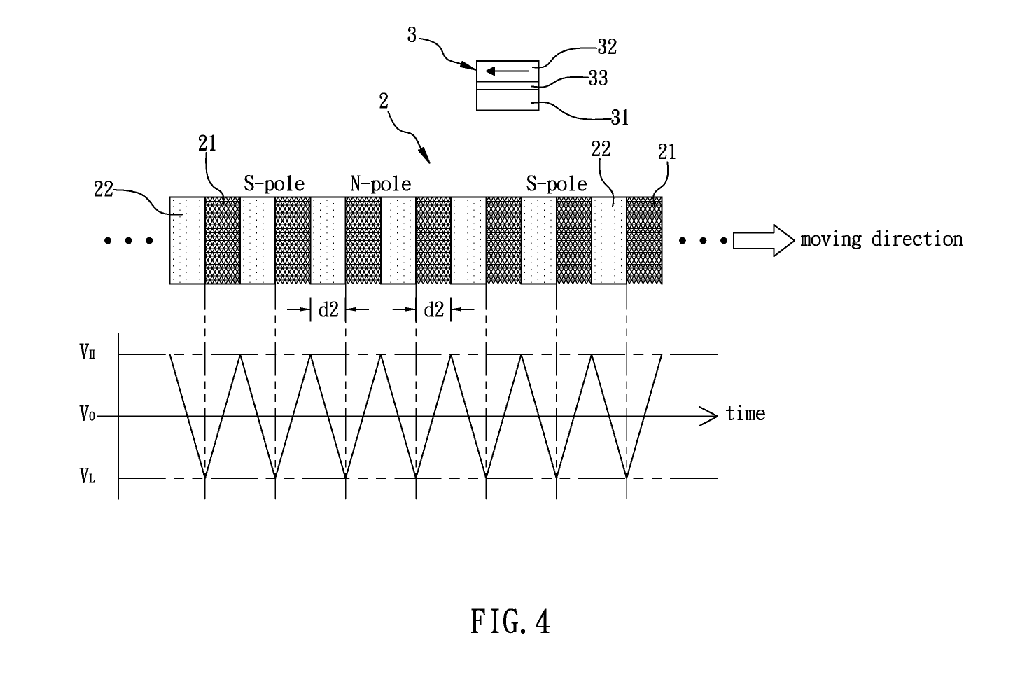

FIG. 4 illustrates another operation of the contactless vibration meter in accordance with the invention. Please refer to FIG. 4, the magnetic stripe 2 has alternatively and equally arranged plurality of N-pole blocks 21 and S-pole blocks 22 with the same lengths (described by d2 as shown in FIG. 4), the corresponding output voltage Vₒᵤₜ detected by the detector 3 (as shown in FIG. 2) is the constant periodical variation of saw-toothed wave (the saw-toothed wave is for example but not limited thereto). The detector 3 passes one pole block once while the processor 4 receives a set of the discrete signals “0” and “1” and the moving distance is the same as the length d2 of the pole block, and further the sequencing of the discrete signals are transferred to corresponding moving distance of the tested object 10.

FIG. 5 illustrates another operation of the contactless vibration meter in accordance with the invention. Please refer to FIG. 5, the magnetic stripe 2 has alternatively and unequally arranged plurality of N-pole blocks 21 and S-pole blocks 22 with the different lengths (described by d3, d4, d5 and d3<d4<d5 as shown in FIG. 5). The lengths of the N-pole blocks and the S-pole blocks increase with increase the distance from the central section 203, the corresponding output voltage Vₒᵤₜ detected by the detector 3 (as shown in FIG. 2) is the irregular periodical variation of saw-toothed wave (the saw-toothed wave is for example but not limited thereto). The detector 3 passes one pole block once while the processor 4 receives a set of the discrete signals “0” and “1” and the moving distance is equal to the relative length of the corresponding pole block because every set of voltage signals (“0” and “1”) with different periods is corresponding to different lengths of the corresponding pole blocks. The corresponding lengths of the pole blocks are shorter (e.g. d3<d4<d5) while the detected periods are shorter. And the processor 4 can reference the relation between the periods of the output voltages and the relative lengths of the corresponding pole blocks to further transfer the discrete signals to corresponding moving distance of the tested object 10 while the processor 4 receives a sequencing of saw-toothed wave output voltage signals with different periods.

Based on the operations in FIG. 3 to FIG. 5, the operation of the contactless vibration meter of the invention is described in detail as following. The magnetic strip 2 comprises a first section 201, a second section 202 and a central section 203. The central section 203 is the equilibrium position while the tested object 10 is static and may be N pole or S pole. In the following illustration, the central section is S pole for reference but not limited thereto. The first section 201 and the second section 202 are respectively connected to two ends of the central section 203, and the connecting portions of the first section 201 close to the central section 203, and the second section 202 close to the central section 203 are the N-pole block 21 or S-pole block 22 whose magnetic field is opposite to that of the central section 203. For example, the central section 203 is S pole, and then the connecting portions of the first section 201 close to the central section 203 and the second section 202 close to the central section 203 are the N-pole block 21 whose magnetic field is opposite to that of the central section 203. In general, the first section 201 and the second section 202 are symmetrically and respectively arranged at the both sides of the central section 203 and centered by the central section 203.

The first section 201 includes a plurality of first N-pole blocks 2011 and a plurality of first S-pole blocks 2012, wherein each first N-pole block 2011 and each first S-pole block 2012 of the first section 201 are alternatively arranged from the end connected to the central section 203 and the lengths of each first N-pole block 2011 and each first S-pole block 2012 of the first section 201 increase with increase the distance from the central section 203. The second section 202 includes a plurality of second N-pole blocks 2021 and a plurality of second S-pole blocks 2022, wherein each second N-pole block 2021 and each second S-pole block 2022 of the second section 202 are alternatively arranged from the end connected to the central section 203 and the lengths of each second N-pole block 2021 and each second S-pole block 2022 of the second section 202 increase with increase the distance from the central section 203. The magnetic direction of the free magnetic layer 31 of the detector 3 can be influenced by the magnetic fields of each first/second N-pole blocks 2011, 2021, and each first/second S-pole blocks 2012, 2022, so that the output voltage Vₒᵤₜ detected by the detector 3 is saw-toothed wave with different periods, and further the processor 4 transfers the sequencing of the discrete signals to the corresponding moving distance of the tested object 10.

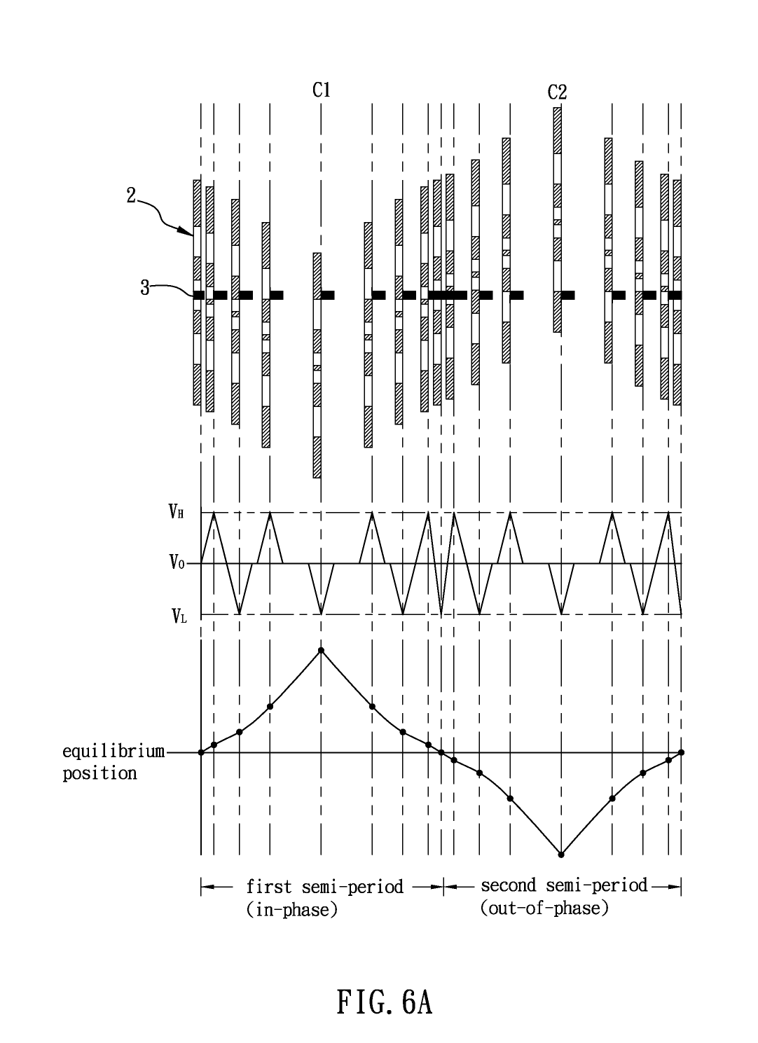

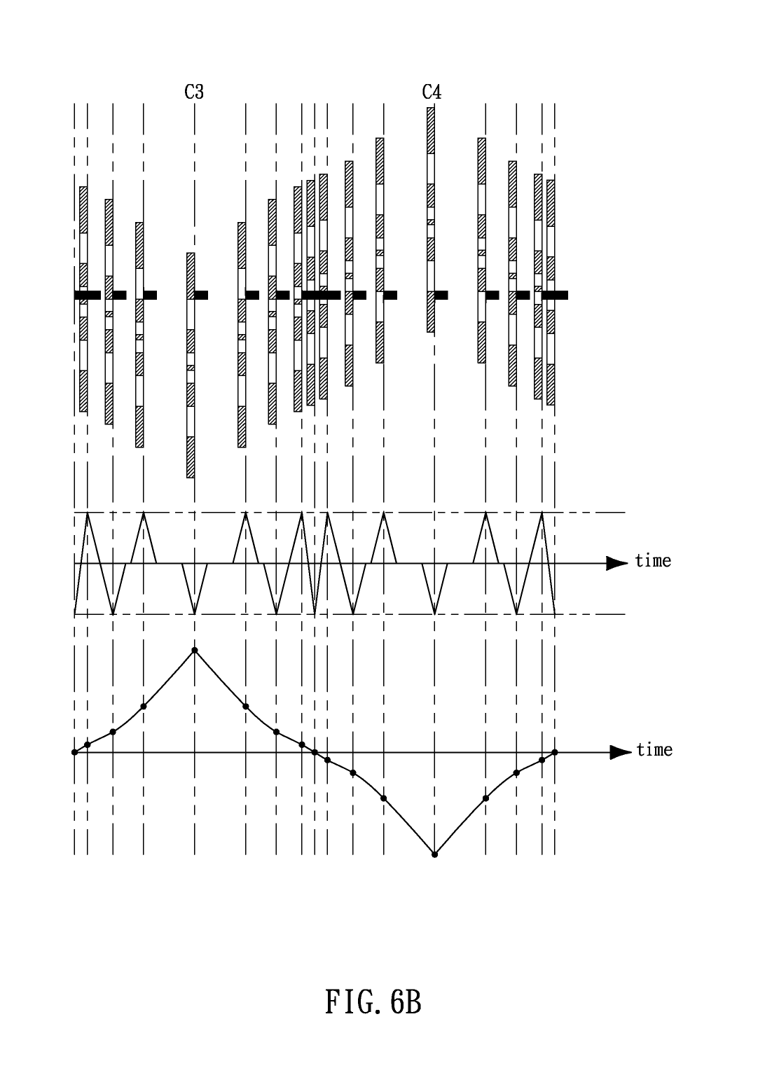

FIGS. 6A and 6B illustrate a working state diagram of the contactless vibration meter in accordance with the invention. The detector 3 is supposed to pass exactly at the junctions between the first N-pole block 2011 and the first S-pole block 2012 or between the second N-pole block 2021 and the second S-pole block 2022 to detect when the tested object 10 has reached its maximum amplitude, i.e. the peak is supposed to locate at the junctions between two different pole blocks so that the detector 3 is capable of detecting the variation of the output voltage Vₒᵤₜ corresponding to the different portions of the magnetic strips 2. The waveform of the output voltages is the saw-toothed wave with different periods and their values are between V_{H} and V_{L}.

Next, how to transfer the waveform of the detected output voltages to corresponding vibration waveform of the tested object 10 is described as following.

How to find equilibrium position? Because the equilibrium position is identical to the central section 203 of the magnetic strip 2 and the length of the pole block is the shortest. Because the period of the output voltage waveform detected by the detector 3 is the shortest, the corresponding frequency of the variation of the output voltage waveforms resulting from the change of the different pole blocks of the magnetic strip 2 is the densest. And then the offset voltage V_{O} without the external magnetic field effect and located at the densest frequency of the variation of the output voltage waveforms is assigned to be the equilibrium position calculated by the processor 4.

How to find its maximum amplitude or peak? Because the maximum amplitude or peak is appeared at the most distant position from the central section 203 and the length of the corresponding pole block is the longest. Because the period of the output voltage waveform detected by the detector 3 is the longest, the corresponding frequency of the variation of the voltage waveforms is the loosest (such as positions C1, C2, C3 and C4 as shown in FIGS. 6A and 6B). As a result, the detector 3 is capable of detecting the total changes of the magnetic direction of the free magnetic layer 31 during the vibration process and further the processor 4 is capable of transferring the signals to corresponding vibration waveform through referencing to the relations between the periods of the output voltage signals and the lengths of the corresponding pole blocks.

How to find in-phase or out-of-phase? The vibration waveform is periodically in reciprocating motion centered by the equilibrium position, and then the output voltages detected by the detector 3 are performing between V_{H} and V_{L} and with dense and loose frequencies of waveform variations. Therefore, during the appearance from the former densest frequency of the variation of the output voltage waveform to the next densest frequency of the variation of the output voltage waveform, it is represented that the vibration waveform is back to the equilibrium position after the vibration waveform increases from the equilibrium position to its maximum amplitude. It implies that the in-phase vibration is getting into the out-of-phase vibration. That is, the vibration waveform has been preceded the first semi-period and is getting into the second semi-period.

However, the vibration waveform transferred from the variations of the output voltages Vₒᵤₜ by the processor 4 are the discrete signals, not the continuous signals. The maximum amplitude corresponding to the voltage signal is just equal to the maximum amplitude of the actual vibration waveform if the peak of the vibration level is positioned exactly at the junction between two different pole blocks. But the maximum amplitude corresponding to the voltage signal is smaller than the maximum amplitude of the actual vibration waveform if the peak of the vibration level is not positioned exactly at the junction point between two different pole blocks.

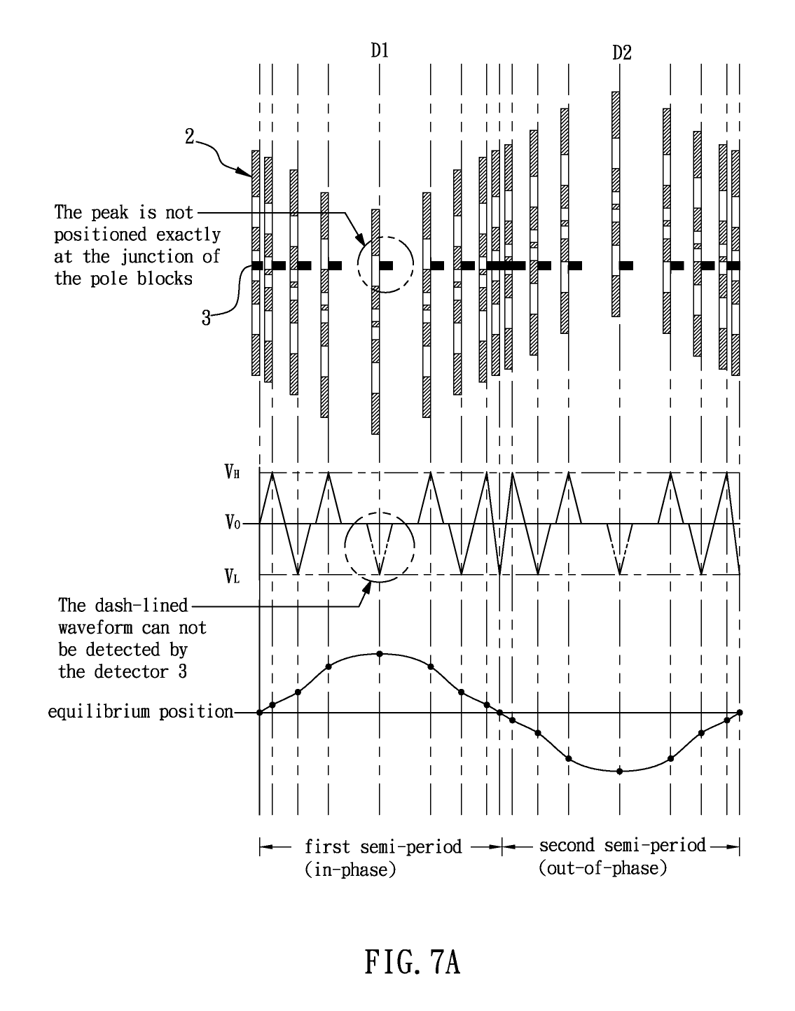

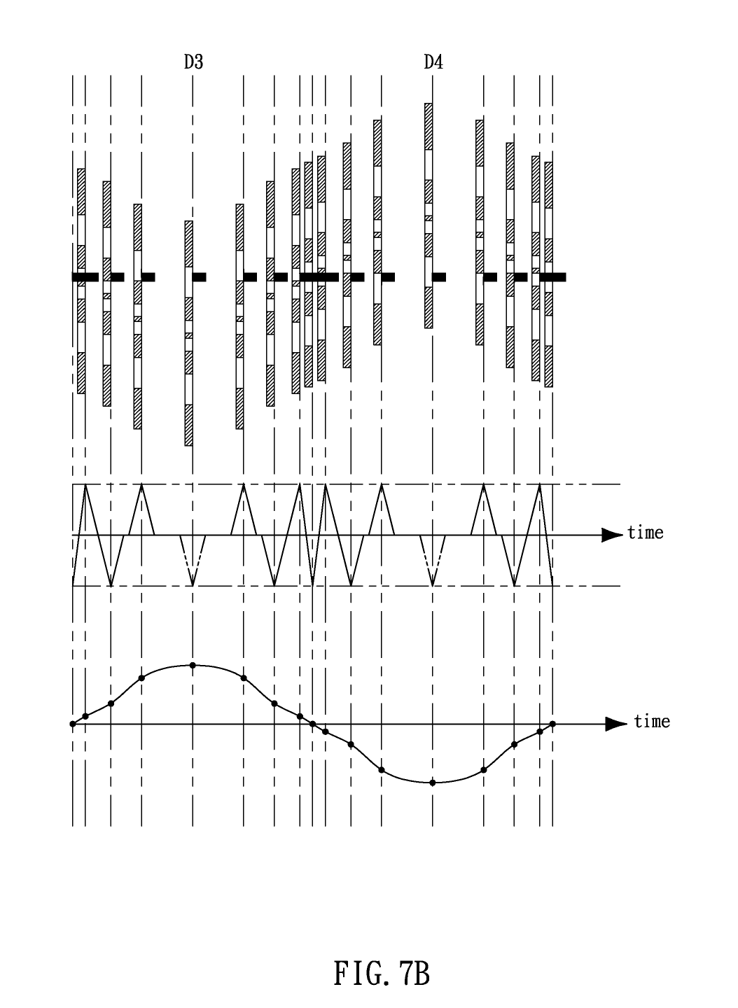

FIGS. 7A and 7B illustrate another working state diagram of the contactless vibration meter in accordance with the invention. The detector 3 is not positioned exactly at the junction between the first N-pole block 2011 and the first S-pole block 2012 or between the second N-pole block 2021 and the second S-pole block 2022 to detect when the tested object 10 has reached its maximum amplitude, i.e. the peak of the vibration level is not positioned exactly at the junction between two different pole blocks. However, in the situation, the detector 3 also can detect the variation of the output voltage Vₒᵤₜ corresponding to the different portions of the magnetic strips 2 and the waveform of the output voltages is the saw-toothed wave between V_{H} and V_{L} and with different periods.

In actual, it is impossible that the peak of the vibration level is positioned exactly at the junction between two different pole blocks every time. Therefore, the change of magnetic direction of the free magnetic layer 31 is not obvious while the detector 3 does not really reach the junction between two different pole blocks as well as the positions B1, B2 and B3 in FIG. 3. Therefore, the output voltages detected by the detector 3 is not influenced by the external magnetic field and the output voltage is the offset voltage V_{O}, not V_{L} or V_{H} (as indicated in the dashed-line circle shown in FIG. 7A).

In this case, the judgment of the equilibrium position, and in-phase or out-of-phase can follow the above mentioned rules as FIGS. 6A and 6B. Besides the judgment of the maximum amplitude or peak can follow the above mentioned rule that it can be appeared at the loosest frequency of the variation of the voltage waveform, it can be also judged at the status while appearing at two continuous high output voltages V_{H} or two continuous low output voltages V_{L} (such as positions D1, D2, D3, D4 as shown in FIGS. 7A and 7B).

When the peak of the vibration level is not just positioned exactly at the junction between two different pole blocks, its maximum amplitude is be detected based on the former pole block closer to the central section 203. The detected maximum amplitude or peak may be lower than that of the actual vibration waveform because the length of the former pole block is shorter than that of the actual corresponding pole block. In this case, it can be improved by involving a second magnetic strip with same lengths of the pole blocks and is described as following.

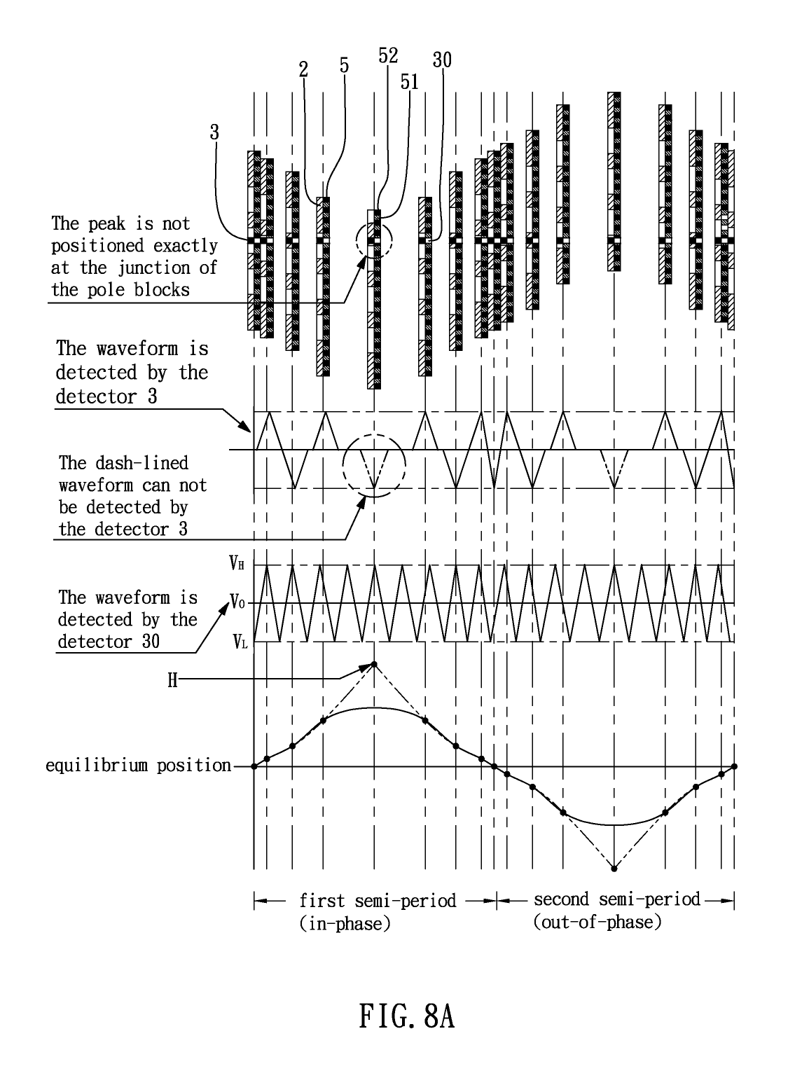

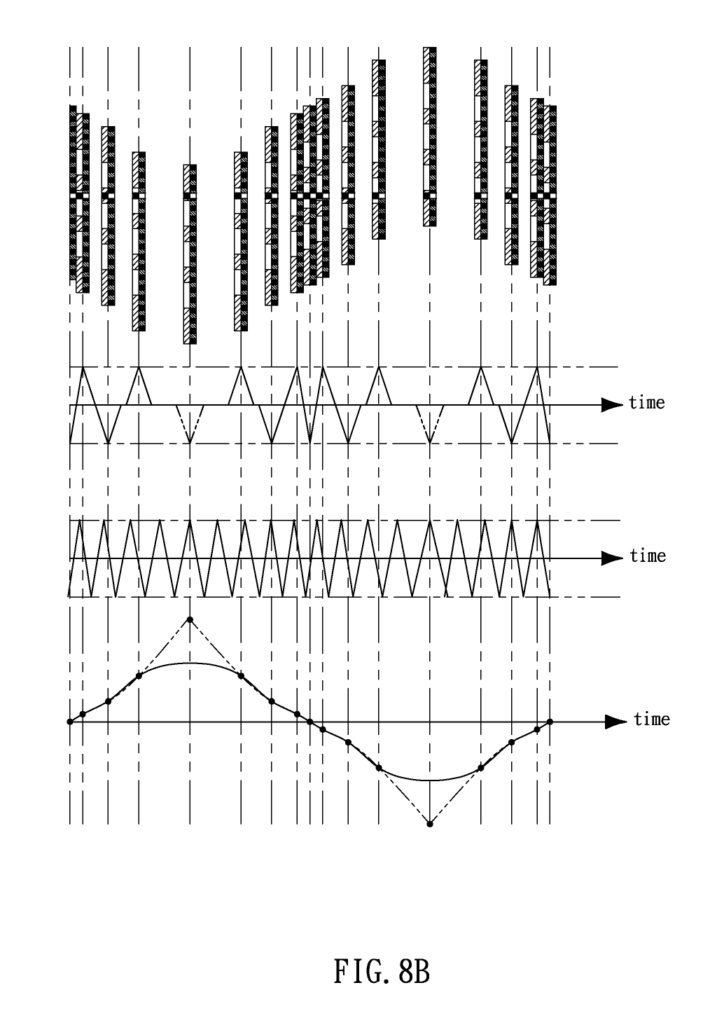

FIGS. 8A and 8B illustrate a working state diagram of the contactless vibration meter involving a second magnetic strip in accordance with the invention. The above mentioned contactless vibration meter 1 is capable of further comprising a second magnetic strip 5 and a second detector 30, wherein the structure of the second magnetic strip 5 is substantially the same as the (first) magnetic strip 2 but the difference is that the length of the third N-pole block 51 and the length of the third S-pole block 52 is the same.

With regards to the (first) magnetic strip 2 whose lengths of the pole blocks are different, it is capable of involving the second magnetic strip 5 whose lengths of the pole blocks are the same. The equilibrium positions of the (first) magnetic strip 2 and the second magnetic strip 5 are identical, and the (first) detector 3 and the second detector 30 are arranged corresponding to the (first) magnetic strip 2 and the second strip 5 respectively to detect two sets of the variations of the output voltage waveforms.

The output voltage signals detected by the (first) detector 3 are the waveform whose densities of the dense and the loose frequencies are different and the waveform is mainly used for judging the equilibrium position and the phase (in-phase or out-of-phase). And the output voltage signals detected by the second detector 30 are the waveform whose densities of the dense and the loose frequencies are the same and the waveform can not be used for judging the equilibrium position and the phase (in-phase or out-of-phase), but it can be used for assisting to judge the maximum amplitude or peak while the peak of the vibration level is just not positioned exactly at the junction between two different pole blocks of the (first) magnetic strip 2 and is described as following.

The maximum amplitude or peak will be underestimated as above mentioned in FIGS. 7A and 7B while the peak of the vibration level is just not positioned exactly at the junction between two different pole blocks of the (first) magnetic strip 2. Because the equilibrium positions of the (first) magnetic strip 2 and the second magnetic strip 5 are located at the same relative position and the second magnetic strip 5 may be used for assisting to calculate the maximum amplitude or peak. The judgment is that if the second magnetic strip 5 is preceding N-S pole blocks conversion for M times since from the equilibrium position to its maximum amplitude or peak, the output voltage Vₒᵤₜ is the regular periodic variation of saw-toothed waveform as shown in FIG. 4. The maximum amplitude or peak detected by the second detector 5 is M*d2 because each time of the pole blocks conversion is represented that the moving distance is identical to the length of one pole block (d2). The maximum amplitude or peak obtained by the (first) magnetic strip 2 and assisted by the second magnetic strip 5 is larger than the one obtained only by the (first) magnetic strip 2 (as indicated by the point H shown in FIG. 8A), and The maximum amplitude or peak obtained by the (first) magnetic strip 2 and assisted by the second magnetic strip 5 is capable of receiving more accurate vibration waveform. The time-domain vibration waveform obtained by the contactless vibration meter 1 according to the invention may be further preceded the Spectrum Analysis by Fourier Transform.

The contactless vibration meter 1 in accordance with the invention has the advantages of noise immunity, high sensitivity and lower power consumption because the (first) detector 3 and the second detector 30 will generate obvious changes of the magnetoresistance influenced by the variations of the external magnetic field of the (first) magnetic strip 2 and the second magnetic strip 5, respectively. In addition, the volume and occupied space of the detectors 3 and 30 may be reduced and minimized because of its high sensitivity to magnetic field. The contactless vibration meter 1 is convenient and suitable for applying in the factory with limited space.

The detectors 3 and 30 have simplified structures and are space-saving, and only weak external magnetic fields applied by the magnetic strips 2 and 5 respectively are required to change the magnetic direction of the free magnetic layer 31 and they do not affect the original magnetic field distribution in the manufacturing process in the factory. Therefore, the material of the magnetic strips 2 and 5 may be slim and flexible with alternatively arranged N-pole and S-pole blocks therein, and a gum (not shown) is disposed at the back of the magnetic strips 2 and 5, a release film (not shown) is adhered on the gum, and the magnetic strip 2 and 5 are attached to detect the vibration information of the tested object 10 by the gum after peeling of the release film without the consideration about the pattern and material of the tested object 10.

Therefore, the contactless vibration meter 1 is capable of being easily installed no mater what the shape, the pattern, the material with/without magnetism of the tested object 10, or the space limitation of the machinery in the factory is. The contactless vibration meter 1 in accordance with the invention includes the flexible installing function, such as portable and “adhere-and-sense” (similar to the function of “plug-and-play”) after attached on a surface of the tested object 10, and further achieves the advantages of space-saving, lower cost, easy installation, lower power consumption, and without affecting the original magnetic field distribution in the manufacturing process.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A contactless vibration meter, comprising:
a magnetic strip, attached on a surface of a tested object and being parallel to the vibrating direction, the magnetic strip having a first section, a second section and a central section, wherein the central section has a magnetic pole with N pole or S pole, the first section and the second section are connected to two ends of the central section respectively, the first section includes at least two first N-pole blocks and at least two first S-pole blocks, the first N-pole blocks and the first S-pole blocks are alternatively arranged from the end of the first section close to the central section and a length of the first N-pole blocks and a length of the first S-pole blocks increase with increase the distance from the central section, and the second section includes at least two second N-pole blocks and at least two second S-pole blocks, the second N-pole blocks and the second S-pole blocks are alternatively arranged from the end of the second section close to the central section and a length of the second N-pole blocks and a length of the second S-pole blocks increase with increase the distance from the central section, and the first section and the second section are connected to the central section with N-pole or S-pole blocks thereof respectively which is opposite to the magnetic pole of the central section;
a detector, attached at a position over the magnetic strip and including a fixed magnetic layer with a fixed magnetic direction, a free magnetic layer with a changeable magnetic direction influenced by an external magnetic field, an insulating layer separated the fixed magnetic layer from the free magnetic layer, two signal lines electrically connected to the fixed magnetic layer and the free magnetic layer respectively, and a power supply electrically connected to the signal lines; and
a processor, electrically connected to the signal lines;
wherein the magnetic strip is passed through the detector in reciprocating motion when the tested object vibrates periodically in reciprocating motion, the changeable magnetic direction of the free magnetic layer is influenced by the magnetic fields of the respective N-pole blocks and the respective S-pole blocks of the first section and the second section to make the magnetic direction of the free magnetic layer be parallel or anti-parallel to the magnetic direction of the fixed magnetic layer; and result in obvious change of the magnetoresistance of the detector and a voltage or current output to the processor, and then the processor calculates the vibration information of the tested object.

2. The contactless vibration meter as claimed in claim 1, wherein the fixed magnetic layer and the free magnetic layer is a conductive metal or an oxide with electric conductivity and magnetism.

3. The contactless vibration meter as claimed in claim 1, wherein the insulating layer is a non-magnetic metal layer or an isolating layer.

4. The contactless vibration meter as claimed in claim 1, wherein the fixed magnetic layer having a pinned layer and a bias layer, the pinned layer is contacting with the insulating layer and the bias layer is used to fix the magnetic direction of the pinned layer, and the bias layer is an anti-ferromagnetic material.

5. The contactless vibration meter as claimed in claim 1, wherein the magnetic strip is flexible and a gum is disposed at a back of the magnetic strip, a release film is adhered on the gum, the magnetic strip is attached on a surface of a tested object by the gum after peeling the release film away.

6. A contactless vibration meter, comprising:
a first magnetic strip, attached on a surface of a tested object and being parallel to the vibrating direction, the first magnetic strip having a first section, a second section and a central section, wherein the central section has a magnetic pole with N pole or S pole, the first section and the second section are connected to two ends of the central section respectively, the first section includes at least two first N-pole blocks and at least two first S-pole blocks, the first N-pole blocks and the first S-pole blocks are alternatively arranged from the end of the first section close to the central section and a length of the first N-pole blocks and a length of the first S-pole blocks increase with increase the distance from the central section, and the second section includes at least two second N-pole blocks and at least two second S-pole blocks, the second N-pole blocks and the second S-pole blocks are alternatively arranged from the end of the second section close to the central section and a length of the second N-pole blocks and a length of the second S-pole blocks increase with increase the distance from the central section, and the first section and the second section are connected to the central section with N-pole or S-pole blocks thereof respectively which is opposite to the magnetic pole of the central section;
a second magnetic strip, being adjacent to the first magnetic strip and having at least two third N-pole blocks and at least two third S-pole blocks, the third N-pole blocks and the third S-pole blocks have the same length and are alternatively arranged;
a first detector, disposed corresponding to the first magnetic strip to detecting a variation of a changeable magnetic direction of each first and second N-pole block and each first and second S-pole block;
a second detector, disposed corresponding to the second magnetic strip to detecting a variation of a changeable magnetic direction of each third N-pole block and each third S-pole block; and
a processor, electrically connecting with the first detector and the second detector;
wherein the processor receives the variations of the changeable magnetic directions detected by the first detector and the second detector to result in obvious change of a magnetoresistance of the first detector and the second detector respectively, and a voltage or current output to the processor, and then the processor integrally calculates a vibration information of the tested object.

7. The contactless vibration meter as claimed in claim 6, wherein the first detector includes a first fixed magnetic layer with a first fixed magnetic direction, a first free magnetic layer with a first changeable magnetic direction influenced by an external magnetic field, a first insulating layer separated the first fixed magnetic layer from the first free magnetic layer, two signal lines electrically connected to the first fixed magnetic layer and the first free magnetic layer respectively, and a power supply electrically connected to the signal lines.

8. The contactless vibration meter as claimed in claim 7, wherein the second detector includes a second fixed magnetic layer with a second fixed magnetic direction, a second free magnetic layer with a second changeable magnetic direction influenced by an external magnetic field, a second insulating layer separated the second fixed magnetic layer from the second free magnetic layer, two signal lines electrically connected to the second fixed magnetic layer and the second free magnetic layer respectively, and a power supply electrically connected to the signal lines.

9. The contactless vibration meter as claimed in claim 8, wherein the first and second fixed magnetic layers and the first and second free magnetic layers is a conductive metal or an oxide with electric conductivity and magnetism, and the first and second insulating layers is a non-magnetic metal layer or an isolating layer.

10. The contactless vibration meter as claimed in claim 8, wherein the first and second fixed magnetic layers having a pinned layer and a bias layer respectively, the pinned layer is contacting with the corresponding insulating layer, and the bias layer is used to fix the magnetic direction of the corresponding pinned layer, and the bias layer is an anti-ferromagnetic material.
